(19) United States
(12) Patent Application Publication
(10) Pub. No.: US 2010/0057633 A1
(43) Pub. Date: Mar. 4, 2010

(54) SYSTEM AND METHOD FOR PROBABILITY-BASED MULTI-GENERATIONAL ESTATE PLANNING

(76) Inventors: Farrukh Zafar, Monroe Township, NJ (US); David Weinreb, Westfield, NJ (US)

Correspondence Address: FOLEY & LARDNER LLP, 150 EAST GILMAN STREET, P.O. BOX 1497, MADISON, WI, 53701-1497, US

(21) Appl. No.: 12/198,356

(22) Filed: Aug. 26, 2008

(51) Int. Cl. G06Q 40/00

(52) U.S. Cl. 705/36 R

(57) ABSTRACT

The systems and methods described calculate ranges of wealth for an estate and for one or more recipients of multi-generational estate transfers. The calculations utilized in the systems and method considered a plurality of options for transferring wealth from a grantor to multi-generational recipients. The systems and methods also process a large number of simulations for different scenarios in the transfer of wealth. The tangible results from the processing of the options and scenarios are probabilistic distributions of total wealth for the giving estate and the receiving generations

### FIELD

The present disclosure relates to estate planning and, more particularly, to systems and methods for probability-based stochastic multi-generational estate planning.

### BACKGROUND

Gift taxes, generation-skipping transfer (GST) taxes, and estate taxes reduce the amount of wealth a donor can transfer to his descendants or other persons. Estate planning attorneys and investment planning professionals use various techniques to minimize these transfer taxes. Historically, the financial modeling of wealth transfer strategies has been limited to assuming that the assets that are the subject of the transfer produce a constant rate of return depending on how they are invested. The assumed rate is typically based on the compound annual rate of return produced by the asset over a specific period in the past. Unfortunately, it is uncertain whether the asset will produce that same compound annual return during the period modeled. Moreover, even if it does, it is highly unlikely that it will produce that return in each year modeled.

As just one example, assume that a client transfers $10 million of publicly traded stocks to a 10-year, zeroed-out grantor-retained annuity trust (GRAT) that he establishes when the Section 7520 rate is 6.0 percent. The GRAT is required to make an annual annuity payment to him of $1,358,677. Table 1 below shows three possible paths of return that the stocks could take over this 10-year period. In each case, the stocks produce a compound annual return of 8 percent. However, the extent to which the GRAT succeeds differs greatly depending on which path of returns the stocks take along the way.

TABLE 1

| Year | Average Return | Return Path 1 | Return Path 2 |
|---|---|---|---|
| 1 | 8.0% | 25.9% | (3.5%) |
| 2 | 8.0 | 41.1 | (1.1) |
| 3 | 8.0 | 11.6 | 2.6 |
| 4 | 8.0 | 14.7 | 2.4 |
| 5 | 8.0 | 9.8 | 6.9 |
| 6 | 8.0 | 6.9 | 9.8 |
| 7 | 8.0 | 2.4 | 14.7 |
| 8 | 8.0 | 2.6 | 11.6 |
| 9 | 8.0 | (1.1) | 14.1 |
| 10 | 8.0 | (3.5) | 25.9 |
| Compound | 8.0 | 8.0 | 8.0 |
| Annual Return | | | |
| GRAT Remainder | $1.9 | $5.7 | $0.0 (failure) |
| ($ Million) | | | |

There is a need for sophisticated probability-based analyses of multi-generational wealth transfer strategies. The platform should allow for analyses of complex estate and investment planning issues by quantifying the probability of achieving a client's objectives. Currently, other than the system described herein, there is no other system in the asset management industry that offers multi-generational investment planning in which the impact on multiple generations of beneficiaries both pre- and post- estate settlement are modeled. Further, other systems do not integrate asset allocation strategies and cash flow requirements for different types of trust vehicles as well as the aggregation of various family accounts to assess the likelihood of meeting stated goals.

### SUMMARY

By way of summary, but not limitation, the present disclosure describes a multi-generational investment planning system and method in which the impact on multiple generations of beneficiaries both pre- and post- estate settlement are modeled. The representative system and method described integrate asset allocation strategies and cash flow requirements for different types of trust vehicles. They also aggregate various family accounts to assess the likelihood of meeting stated estate planning goals.

A representative multi-generational system and method enable holistic investment-planning analyses for complex wealth transfer issues. For example, the system provides estate planning features, including an actuarial death model, credit shelter trust, inherited IRAs, state death tax, estate distribution, gift and generation-skipping-transfer taxes and estate taxes. In an example embodiment, analyses involve a Monte Carlo model that simulates 10,000 plausible future paths of returns for each asset class and inflation and produces a probability distribution of outcomes. The model also simulates 10,000 plausible paths for the Section 7520 rate. However, the model does not randomly draw from a set of historical returns to produce estimates for the future. Instead, forecasts (1) are based on the building blocks of asset returns, such as inflation, yields, yield spreads, stock earnings, and price multiples; (2) incorporate the linkages that exist among the returns of various asset classes; (3) take into account current market conditions at the beginning of an analysis; and (4) factor in a reasonable degree of randomness and unpredictability. In addition, in the mortality adjusted analyses, the lifespan of an individual varies in each of our 10,000 trials in accordance with the mortality tables. For example, there's a 50 percent chance that at least one member of a 65-year-old couple will survive until age 92. Consequently, in a mortality-adjusted analysis for that couple, at least one will survive until age 92 in half of the 10,000 scenarios we model; in the other half, both die at some earlier time.

A representative wealth forecasting system creates a probabilistic analysis of a family's wealth after evaluating various estate planning strategies and asset allocations. The system simulates at least 10,000 potential outcomes for the assets under analysis, and incorporates a host of variables specific to the clients and strategies under analysis, including a client's expected year of death, retirement age, assets, income and transfer taxes, charitable donations and risk profile. The output of the analysis is a series of easy-to-read investment plan consisting of charts and graphs.

A representative wealth forecasting system consists of four core modules: a web-based user interface to capture investment planning data, a wealth forecasting engine (WFE) to simulate at least 10,000 portfolio paths, a capital markets engine (CME) for capital markets projection of various asset classes, and a reporting engine to create holistic investment plans.

According to one representative embodiment, a method of probability-based multi-generational estate planning includes creating projections of estate planning options using information regarding assets of a client, recipients of asset transfers, tax information, and asset transfer parameters; calculating possible yields for the client, heirs of the client, and other recipients of assets from the client based on the created projections; and presenting the possible yields for the client, the heirs, and the other recipients, wherein the heirs include multiple generations and the possible yields include pre-death and post-death outcomes.

According to another representative embodiment, a data processing system for modeling potential outcomes of investment choices involving a plurality of estate distribution selections includes a computer processor configured to process data and storage containing programmed instructions for execution by the computer processor. The programmed instructions are configured to instruct the computer processor to carry out simulations for a plurality of estate planning options using information regarding assets of a client, recipients of asset transfers, tax information, and asset transfer parameters. The simulations include possible yields for the client, heirs of the client, and other recipients of assets from the client.

These and other features, aspects and advantages will become apparent from the following description, appended claims, and the accompanying representative embodiments shown in the drawings, which are briefly described below.

### BRIEF DESCRIPTION OF DRAWINGS

FIG. 1 is a diagram illustrating options available in a multi-generational wealth transfer system in accordance with a representative embodiment.

FIG. 2 is a diagram depicting operations performed in an estate transfer projection system in accordance with a representative embodiment.

FIG. 3 is a diagram depicting operations performed in an estate transfer projection according to a representative embodiment.

FIG. 4 is a diagram depicting an investment planning process in accordance with a representative embodiment.

FIG. 5 is a diagram depicting a general architecture of a wealth forecasting system in accordance with a representative embodiment.

FIG. 6 is a diagram depicting operations performed in an estate transfer projection according to a representative embodiment.

FIG. 7 is a flow diagram of operations performed in a representative wealth forecasting analysis process.

FIGS. 8 to 14 are graphs showing results from the application of a wealth forecasting analysis to various scenarios according to a representative embodiment.

### DETAILED DESCRIPTION

Representative embodiments are described below with reference to the accompanying drawings. It should be understood that the following description is intended to describe representative embodiments of the invention, and not to limit the invention.

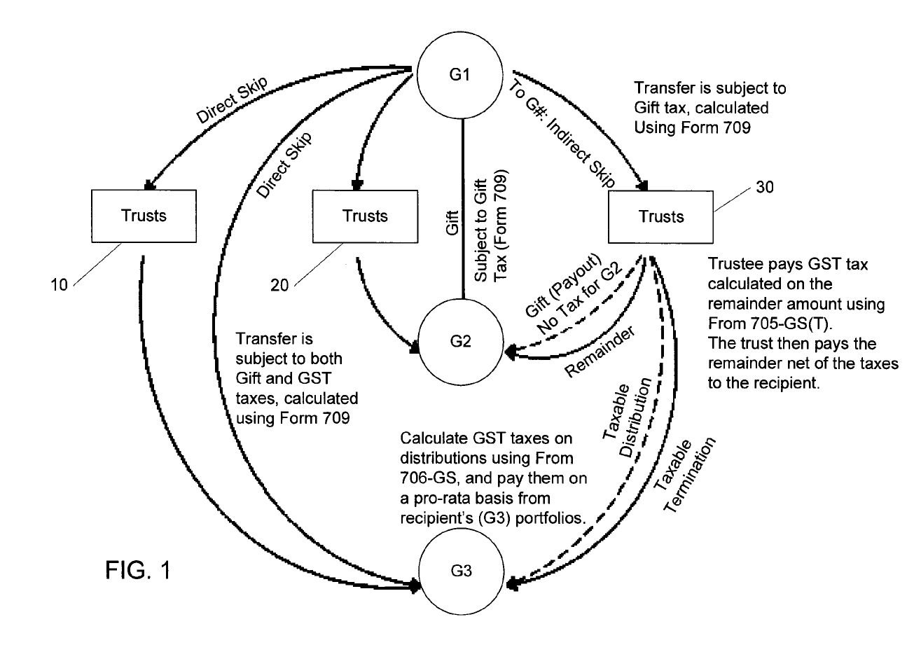

FIG. 1 illustrates a representative architecture for multi-generational wealth transfer. Five different options for transfer from a higher-generation grantor (G1) are depicted. In the first option, G1 transfers funds to a trust 10 solely for the benefit of one or more beneficiaries (G3) who are in a generation that is two or more generations below G1's generation. In a second option, grantor G1 transfers the wealth directly to recipient G3. These two types of transfers, which are known in the tax law as “direct skips,” may result in the use of a portion of the G1's “unified credit” against gift and estate taxes and/or may use a portion of G1's generation-skipping transfer (“GST”) tax exemption and/or be subject to gift tax and/or GST tax. In a third option, grantor G1 transfers funds to a trust 20 solely for the benefit of one or more beneficiaries (G2) who are in the generation one generation below G1's generation. In a fourth option, grantor G1 transfers the wealth directly to recipient G2. These two types of transfers may use a portion of G1's unified credit against gift and estate taxes and/or may be subject to gift tax.

In a fifth option, grantor G1 transfers funds to a trust 30 for the benefit of both G2 and G3 beneficiaries. This transfer may use a portion of G1's unified credit against gift and estate taxes and/or a portion of the G1's GST exemption and/or may be subject to gift tax. In addition, if a distribution is made from the trust to a G3 beneficiary, the distribution may be subject to GST tax. A wealth forecasting system can account for these transfers taking place in a single year or over many years and can compute and track any use of tax exemptions and/or credits and/or payments of transfer taxes resulting from these transfers. (It should also be noted that, at G1's death, his assets may be subject to estate tax, which the wealth forecasting system also computes.) The wealth forecasting system can account for “gift-splitting” of gifts by a married couple for gift tax purposes.

In the situation where there are split gifts with separate transfer tax information, the system captures the transfer tax information on a user interface for both the self and spouse relationships. This information is used to process individual IRS Form 709 using half of each gift amount. After calculating the gift and GST taxation for both individuals, the system 100 aggregates these taxes and pays them from the personal portfolio.

In the situation where there is no gift splitting with a grantor's transfer tax information, the system captures transfer tax information on a user interface for a self relationship only. The system processes the IRS Form 709, calculates the gift and GST, and pays it from the personal portfolio.

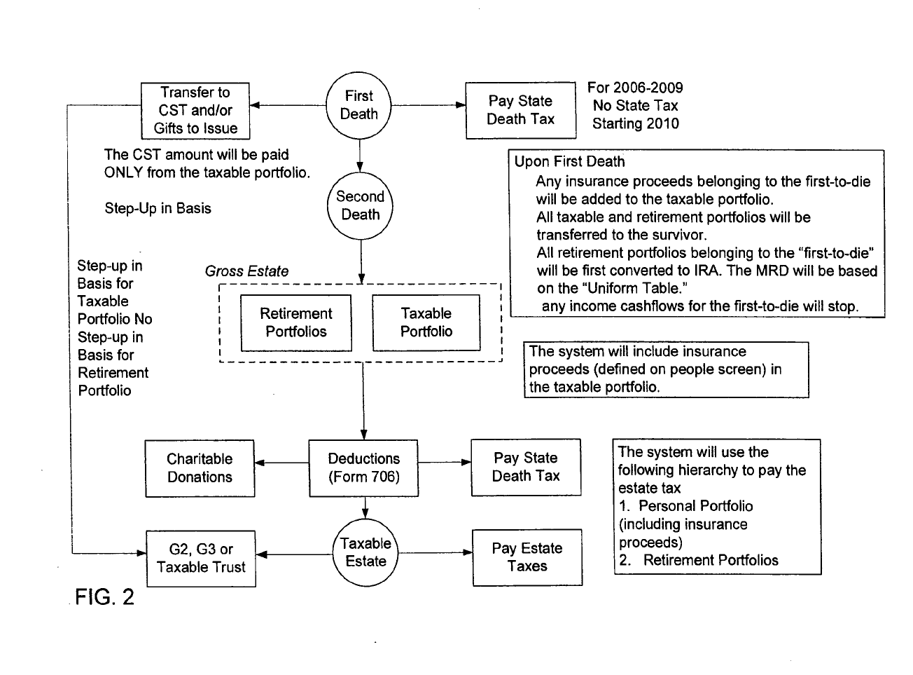

FIG. 2 illustrates operations performed in a representative asset transfer and taxation system. Additional, fewer, or different operations may be performed depending on the particular embodiment. Upon the death of the first member of a married couple to die, any insurance proceeds belonging to the first-to-die are added to his or her individually-owned assets. An amount equal to the largest amount that can pass free of Federal estate tax by reason of the unified credit against gift and estate taxes (or, if desired, the largest amount that can pass without state death tax, if less) is computed. This amount passes to a trust for the benefit of the surviving spouse and/or descendants of the first-to die, or directly to one or more of those descendants. Any state death taxes are paid. The balance of the first-to-die's individual and retirement portfolios (e.g., individual retirement accounts) pass outright to the surviving spouse. All of the first-to-die's retirement portfolios are assumed to be “rolled over” by the survivor. The minimum required distributions (“MRDs”) from the retirement portfolios to the survivor are computed based on the IRS's “Uniform Lifetime Table.” At the survivor's death, estate and/or GST taxes are computed, taking account of any deductions to which the survivor's estate may be entitled for gifts to charity and/or the payment of state death taxes. The balance of the estate passes to recipient G2, recipient G3, or trusts for their benefit, as outlined in the options illustrated and described with reference to FIG. 1.

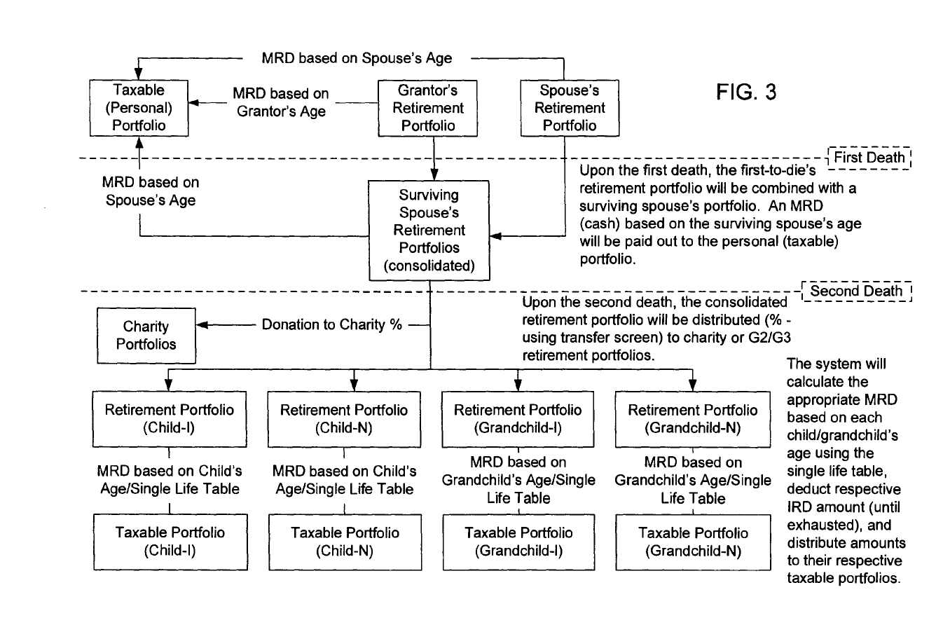

FIG. 3 is another depiction of operations performed in the representative estate transfer and taxation system. During the lifetimes of a grantor and his or her spouse, MRDs to the grantor or spouse from an IRA or qualified retirement plan that he or she owns are based on the IRS's Uniform Lifetime Table. At the death of the first member of a married couple to die, the surviving spouse is assumed to roll over the balance of the decedent's retirement account into an IRA owned by the surviving spouse. MRDs to the surviving spouse are based on the IRS's Uniform Lifetime Table. Upon the death of the surviving spouse, his or her retirement accounts are distributable. To the extent the retirement accounts are payable to a descendant and MRDs are computed based on that descendant's age using the IRS's single lifetime table, all or a portion of the surviving spouse's retirement accounts may also be payable to charity.

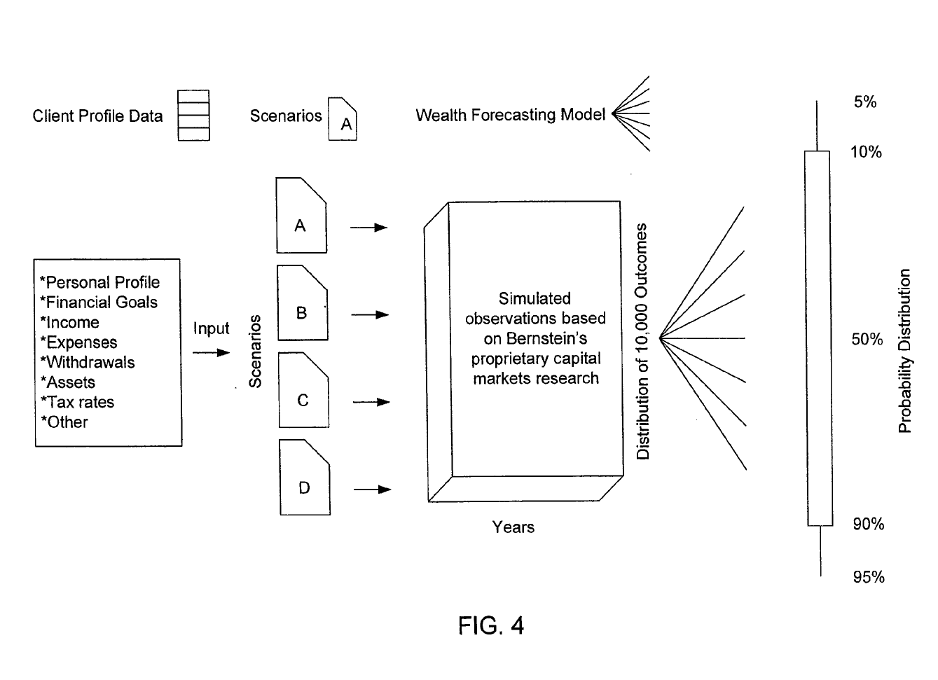

FIG. 4 illustrates an investment planning process using a wealth forecasting system. A platform captures a client profile (financial goals, time horizon, risk tolerance, assets, income, spending, withdrawals, tax rates, target allocation) and allows the financial advisors to construct up to four strategies (labeled as A, B, C and D in the diagram). The system then combines the financial and taxation architecture of modeled portfolios in the forecast with the underlying projected asset returns, and creates 10,000 portfolio paths. The system uses the rich forecast data to quantify the strategies in the form of a holistic investment plan.

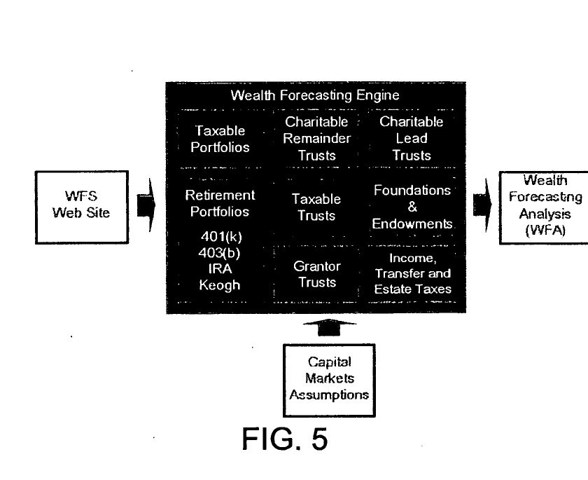

FIG. 5 illustrates the architecture of a representative forecasting system. The system consists of four core modules: a web-based front-end, capital markets engine (CME), wealth forecasting engine (WFE), and wealth forecasting analysis (WFA). These modules are described in detail in the following paragraphs.

The web-based front-end uses a web-based user interface to capture investment planning information. The web-based interface allows financial advisors to use this platform “at anytime and from anywhere.” The architecture also enables the development of a multi-tier software design, which promotes modular design and helps segregate the complex analytical engine from the presentation and data layers.

The capital markets engine (CME) provides certain assumptions about future market returns. The CME provides projected returns and income for 34 asset classes over the next 50 years. Instead of using the simpler Monte Carlo methodology, which randomly samples historical capital market information, the CME uses a mathematical model to capture the serial- and cross-correlations among various asset classes.

Rather than using a constant set of assumptions (typically drawn from a “representative” historical period), the wealth forecasting system projects returns consistently with the current pricing of financial markets. More specifically, each path starts with today's market conditions - such as today's inflation, bond yields, and stock valuations. For instance in 1980, the 30-year U.S. Treasury bond yield was 13.5%, whereas the average return to the corresponding instrument over the prior 30 years was 2.1%. Since the investor could purchase the bond and hold it to maturity for a return of 13.5% (ignoring reinvestment risk—so this is strictly only true for zero coupon instruments), that number should be a best guess of the future return.

The system incorporates all the data up to today in forecasting future scenarios. The projections of the system look at not just a snapshot of the starting conditions, but also at the path used to get there (via variables such as equity price momentum, lagged inflation, lagged value-to-growth premium, etc.). This condition holds true for each intermediate point in a projected path. More technically, the system uses a model with a vector auto-regression structure to capture the impact of lagged variable values. In addition, the model is periodically updated so that its parameters reflect all available history.

The wealth forecasting engine serves as the central processing unit for the system. This module contains sophisticated financial and taxation models for various investment vehicles, including taxable and retirement—401(k), 403(b), IRA, Keogh- portfolios, taxable trusts, charitable lead trusts, charitable remainder trusts, grantor retained trusts, foundations and endowments. The module also has sophisticated models for income, transfer and estate taxation.

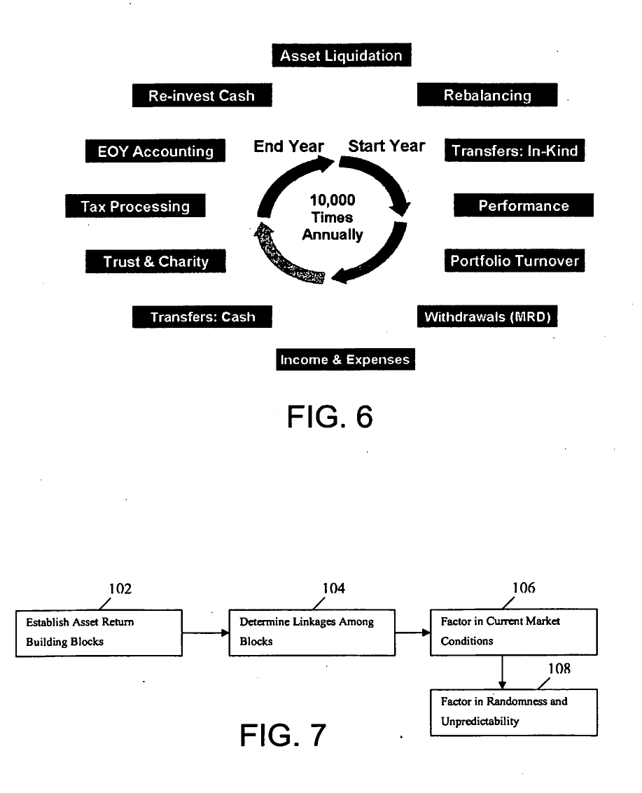

The wealth forecasting analysis (as shown in FIG. 6) simulates the annual asset management cycle, and using capital market assumptions, develops 10,000 portfolio outcomes for each year. The engine conducts sophisticated statistics to develop and present investment-planning trade-off choices.

FIG. 7 shows a representative wealth forecasting analysis process. Additional, fewer, or different operations may be performed in carrying out the process. In an operation 102, asset return building blocks are established. Asset return building blocks can include inflation, yields, yield spreads, stock earnings and price multiples. In an operation 104, linkages and relationships existing among the asset return building blocks are determined. For example, different correlations exist between building blocks.

In an operation 106, current market conditions are factored in. Current market conditions are better predictors of future performance than historical ones. Current market conditions can include trends based on past performance. In an operation 108, randomness and unpredictability are factored into calculations to account for probability variations.

The following provides an example of the wealth forecasting analysis process described herein. In this example, it is assumed that the grantor (G1) and spouse are 58 and 56 years old, respectively, live in Wyoming, and each dies at age 95. They are assumed to have three children in their 20s. Their initial assets are $140 million, allocated 60% to equities and 40% to bonds. They spend $1.5 million (growing with inflation). They also have a $7 million private foundation, allocated 70% to equities and 30% to bonds. They will contribute $200,000 annually from their investment portfolio to the foundation, which distributes 5% of the value of its assets each year to charity. They “split” gifts for gift tax purposes. It is further assumed that at the grantor's death, he gives the maximum amount that can pass free of federal estate tax by reason of the unified credit against estate tax to a “Credit Shelter Trust.”

| | |
|---|---|
| Scenario A | There is a irrevocable life insurance trust (ILIT) that holds a $10 million |
| | second-to-die life insurance policy on the lives of the grantor and spouse. |
| | The annual premiums of $39,282 are paid by the grantor. The grantor and |
| | spouse currently make annual gifts to the ILIT that are used to pay the |
| | premiums. One-third of each gift is treated as an “annual exclusion” gift to |
| | each of your children. |
| Scenario B | Scenario A + the grantor creates a Family LLC that he funds with his |
| | personal assets. An LLC interest with an undiscounted value of $65 |
| | million is transferred to a “zeroed-out” 20-year Grantor Retained Annuity |
| | Trust (GRAT). The LLC interest is assumed to be subject to a 20% |
| | “valuation discount.” The annuity payment from the GRAT increases by |
| | 20% each year. Any principal remaining in the GRAT at the end of its |
| | term passes to a Grantor Trust for the benefit of the grantor's children. |
| Scenario C | Scenario A + the grantor commits $65 million of equities to a series of |
| | “zeroed-out” 2-year “rolling” GRATs. Any amount remaining in any |
| | successful GRAT passes to a Grantor Trust for the benefit of the grantor's |
| | children. |

Table 2 below summarizes the assumptions and conditions for the Scenarios A, B, and C described above.

TABLE 2

| | Scenario A | | | Scenario B | | | Scenario C | | |
|---|---|---|---|---|---|---|---|---|---|
| | Existing Plan | | | LLC to GRAT | | | Rolling GRATs | | |
| | | | Hedge | | | Hedge | | | Hedge |
| | Stocks | Bonds | Funds | Stocks | Bonds | Funds | Stocks | Bonds | Funds |
| | (%) | (%) | (%) | (%) | (%) | (%) | (%) | (%) | (%) |
| Your Assets | | | | | | | | | |
| Personal Portfolio | 60.0 | 40.0 | | 60.0 | 40.0 | | 60.0 | 40.0 | |
| 20 Year GRAT | | | | 100.0 | | | | | |
| Roling GRATs | | | | | | | 100.0 | | |
| Children's Assets | | | | | | | | | |
| Children's Assets | 80.0 | 20.0 | | 80.0 | 20.0 | | 80.0 | 20.0 | |
| CST | 60.0 | 40.0 | | 60.0 | 40.0 | | 60.0 | 40.0 | |
| Grantor Trust | | | | 80.0 | 20.0 | | 80.0 | 20.0 | |
| Foundation's Assets | | | | | | | | | |
| Foundation | 70.0 | 30.0 | | 70.0 | 30.0 | | 70.0 | 30.0 | |

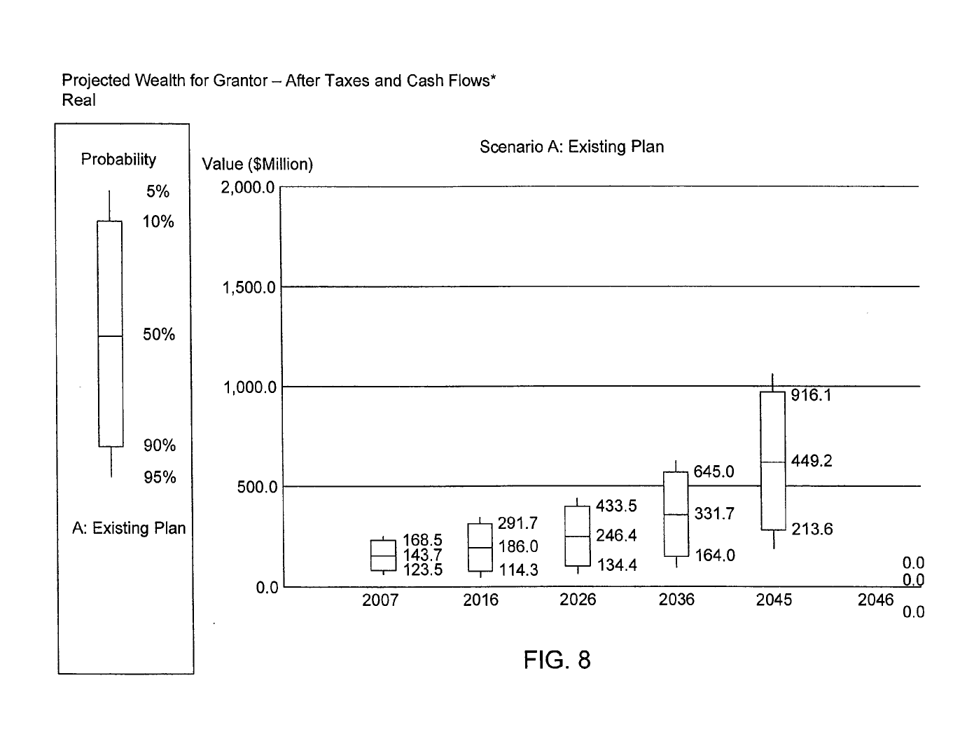

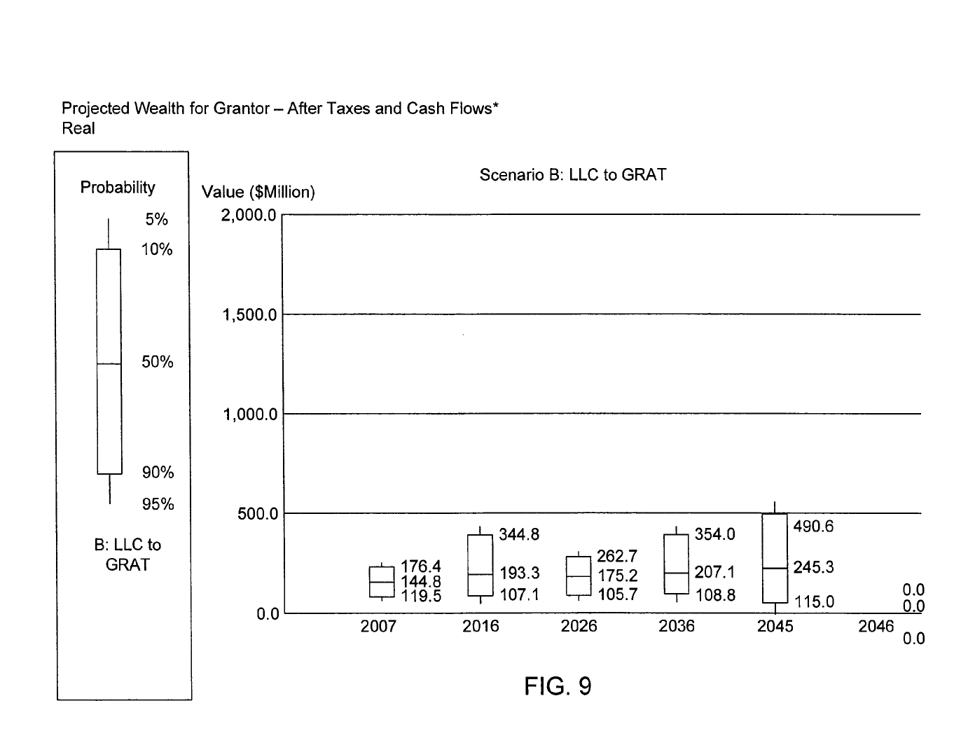

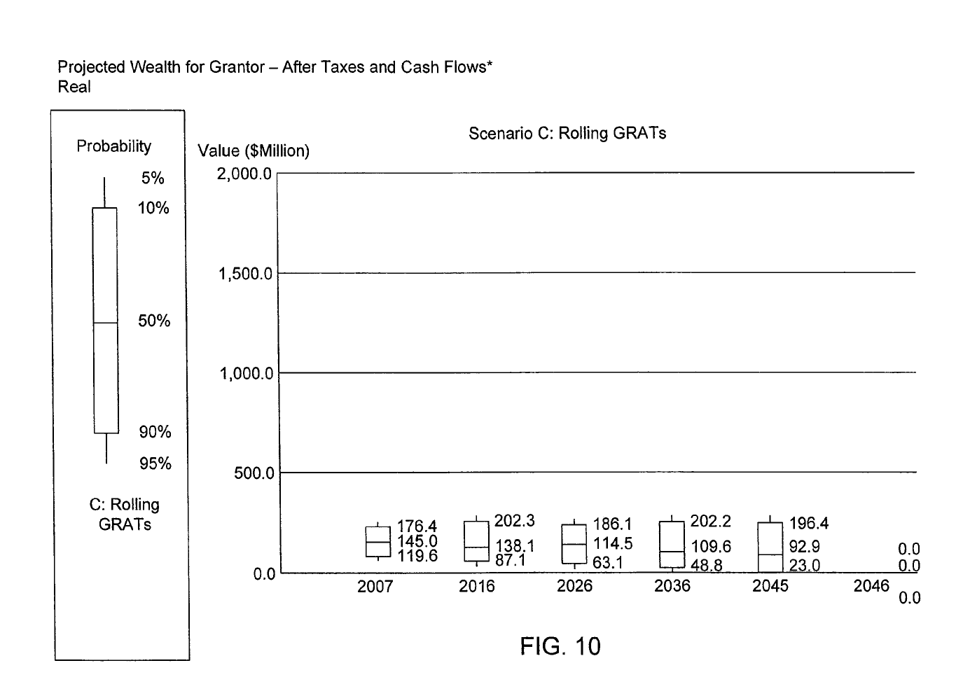

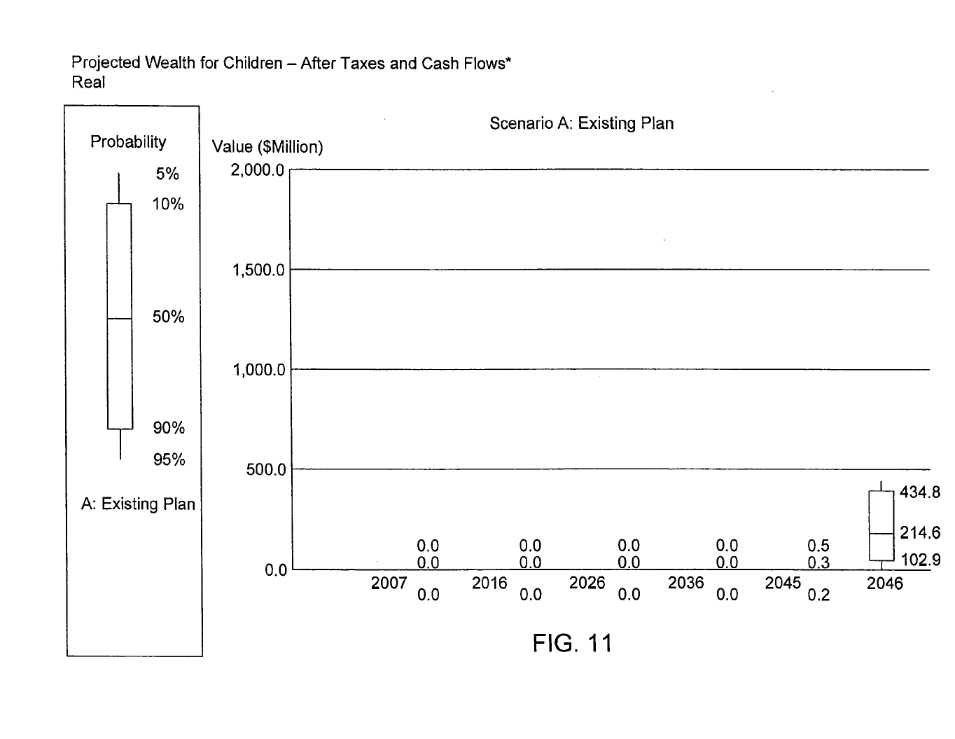

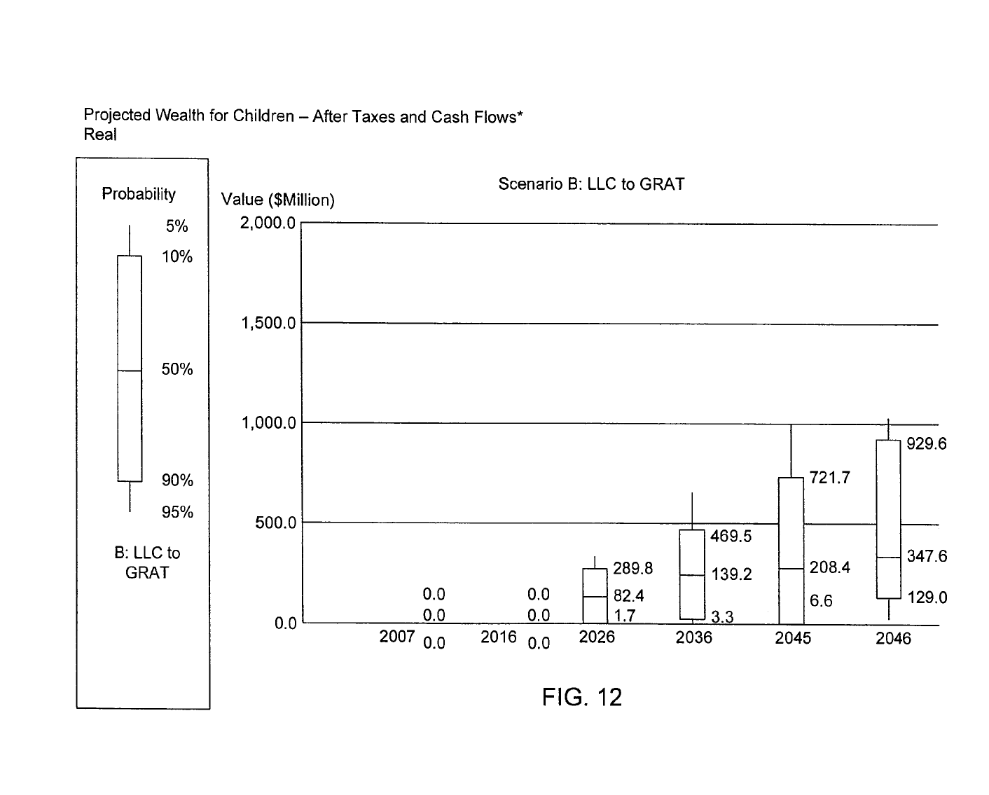

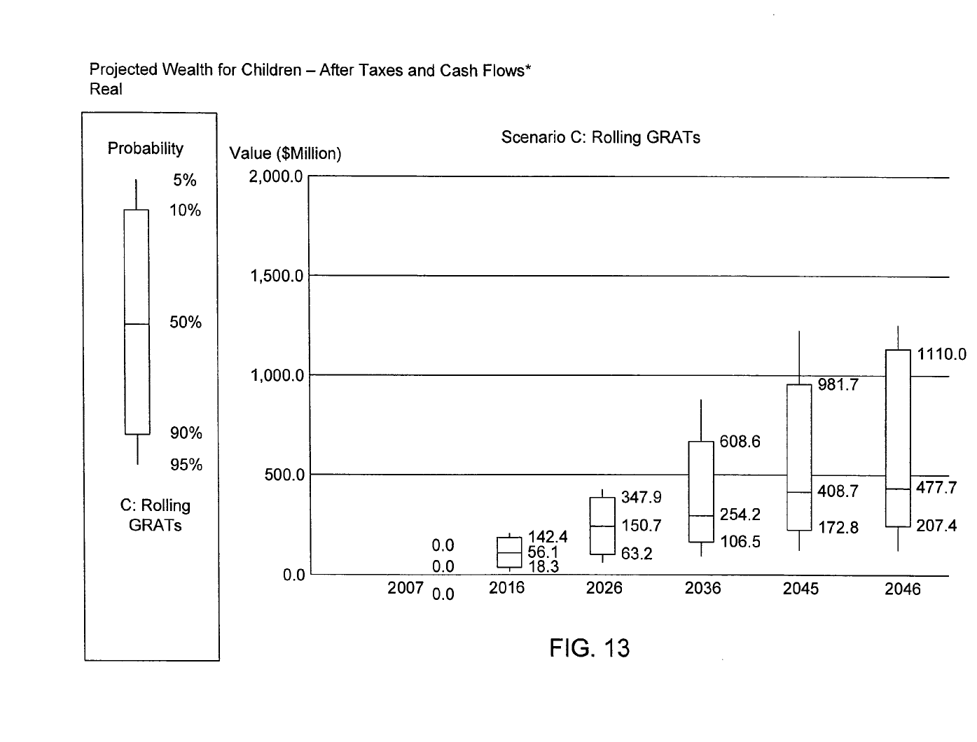

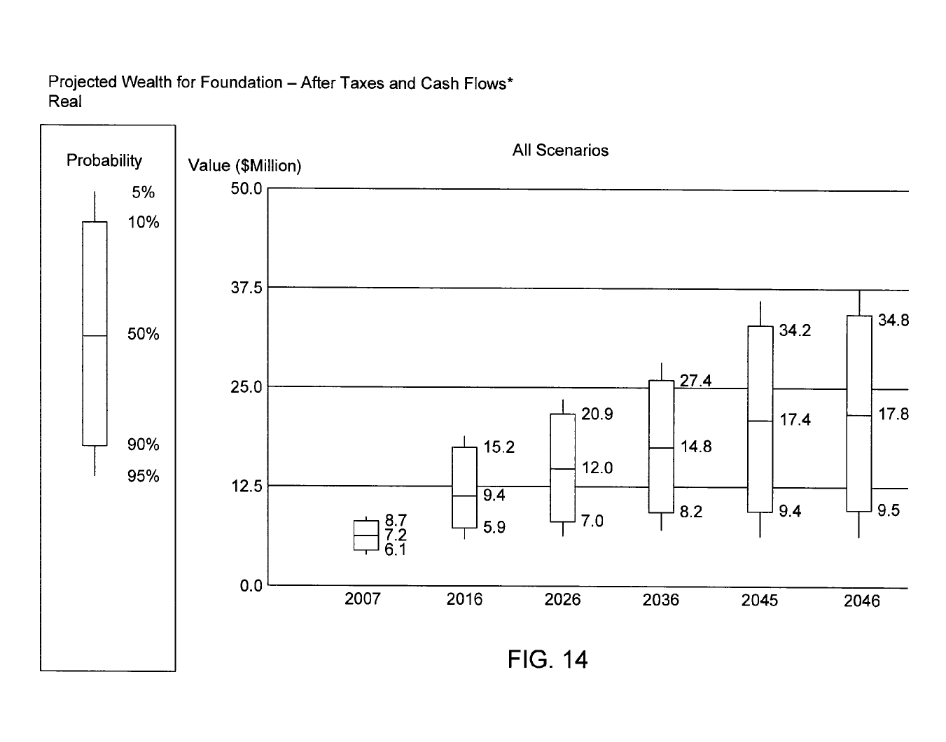

FIGS. 8 to 14 depict results from the application of the wealth forecasting analysis to Scenarios A, B, and C described above. FIG. 8 shows projected real values wealth for the grantor after taxes and cash flows where Scenario A is used. FIG. 9 shows projected real values wealth for the grantor after taxes and cash flows where Scenario B is used. FIG. 10 shows projected real values wealth for the grantor after taxes and cash flows where Scenario C is used. FIG. 1 I shows projected real values wealth for the grantor's children after taxes and cash flows where Scenario A is used. FIG. 12 shows projected real values wealth for the grantor's children after taxes and cash flows where Scenario B is used. FIG. 13 shows projected real values wealth for the grantor's children after taxes and cash flows where Scenario C is used. FIG. 14 shows projected real values wealth for the grantor's foundation after taxes and cash flows.

The foregoing description of representative embodiments has been presented for purposes of illustration and description. It is not intended to be exhaustive or to limit the possible implementations to the precise forms disclosed.

What is claimed:

1. A system for modeling potential outcomes of investment choices involving estate distribution selections of an estate principal, potential heirs, and possible recipients of at least a portion of an estate distribution, the system comprising:
a database containing financial information relating to assets of a client, recipients of asset transfers, tax information, and asset transfer parameters; and
a processor having programmed instructions to:
create projections of estate planning options and, based on the created projections, calculate possible yields for the client, heirs of the client, and other recipients of assets from the client; and
present the possible yields for the client, the heirs, and the other recipients, wherein the heirs include multiple generations and the possible yields include pre-death and post-death outcomes.

2. The system of claim 1, wherein the projections of estate planning options are created using a Monte Carlo model.

3. The system of claim 2, wherein the projections include at least 10,000 projections.

4. The system of claim 1, wherein the projections of estate planning options include adjustments for mortality rate which adjust potential lifespan for the client.

5. The system of claim 1, further comprising an interface configured to receive financial information from a network.

6. The system of claim 1, wherein the projections of estate planning options are path-dependent.

7. The system of claim 1, wherein the possible yields are presented by displaying probabilities and ranges for yields on separate graphs for each of the client, heirs, and the other recipients.

8. A method of probability-based multi-generational estate modeling, the method comprising:
creating projections of estate planning options using information regarding assets of a client, recipients of asset transfers, tax information, and asset transfer parameters;
calculating possible yields for the client, heirs of the client, and other recipients of assets from the client based on the created projections; and
presenting the possible yields for the client, the heirs, and the other recipients, wherein the heirs include multiple generations and the possible yields include pre-death and post-death outcomes.

9. The method of claim 8, further comprising receiving information regarding assets of a client, recipients of asset transfers, tax information, and asset transfer parameters via a web interface.

10. The method of claim 8, wherein presenting the possible yields for the client, the heirs, and the other recipients comprises presenting possibilities and ranges of possible yields on a graph for each of the client, the heirs, and the other recipients.

11. The method of claim 8, wherein creating projections of estate planning options utilizes a Monte Carlo model.

12. The method of claim 11, wherein at least 10,000 portfolios paths are included in simulations in the Monte Carlo model.

13. The method of claim 8, wherein the projections of estate planning options include adjustments for mortality rate which adjusts potential lifespan for the client.

14. A data processing system for modeling potential outcomes of investment choices involving a plurality of estate distribution selections, the data processing system comprising:
a computer processor configured to process data; and
storage configured to store data and programmed instructions for execution by the computer processor, wherein the programmed instructions are configured to instruct the computer processor to carry out simulations for a plurality of estate planning options using information regarding assets of a client, recipients of asset transfers, tax information, and asset transfer parameters, wherein the simulations include possible yields for the client, heirs of the client, and other recipients of assets from the client.

15. The data processing system of claim 14, wherein the programmed instructions are further configured to present the possible yields for the client, the heirs, and the other recipients, wherein the heirs include multiple generations and the possible yields include pre-death and post-death outcomes.

16. The data processing system of claim 15, wherein the possible yields are presented by displaying probabilities and ranges for yields on separate graphs for each of the client, heirs, and the other recipients.

17. The data processing system of claim 14, wherein the simulations for a plurality of estate planning options include adjustments for mortality rates which adjust potential lifespan for the client.

18. The data processing system of claim 14, further comprising an interface configured to receive financial information from a network.

19. The data processing system of claim 14, wherein the simulations utilize a Monte Carlo model.

20. The data processing system of claim 19, wherein the simulations include at least 10,000 portfolio paths.
